(19) United States
(12) Patent Application Publication
(10) Pub. No.: US 2021/0309488 A1
(43) Pub. Date: Oct. 7, 2021

(54) ELEVATOR SAFETY SYSTEMS

(71) Applicant: Otis Elevator Company, Farmington, CT (US)

(72) Inventor: Jan Ruhnke, Berlin (DE)

(21) Appl. No.: 16/953,762

(22) Filed: Nov. 20, 2020

(30) Foreign Application Priority Data
Apr. 6, 2020 (EP) 20168216.8

(51) Int. Cl. B66B 5/16; B66B 1/32; B66B 1/34

(52) U.S. Cl. CPC B66B 5/16; B66B 1/3492; B66B 1/32

(57) ABSTRACT

An elevator safety system for an elevator system including: a position reference system configured for determining a current position of an elevator car within the elevator system; at least one brake configured to bring the elevator car to a safe stop; a controller configured to activate the at least one brake; the controller configured to: receive data from the position reference system; calculate a current acceleration from the current position of the elevator car; compare the current acceleration to a predetermined acceleration threshold; and activate the at least one brake when the current acceleration exceeds the predetermined acceleration threshold.

### FOREIGN PRIORITY

This application claims priority to European Patent Application No. 20168216.8, filed Apr. 6, 2020, and all the benefits accruing therefrom under 35 U.S.C. § 119, the contents of which in its entirety are herein incorporated by reference.

### TECHNICAL FIELD

This disclosure relates to elevator safety systems, and to methods of operating elevator safety systems.

### BACKGROUND

Elevator systems generally comprise an elevator car moving within a hoistway between a plurality of landings. Elevator cars are guided by rails disposed in the hoistway, and safety aspects, including brakes, are disposed in the vicinity of the elevator guide rails.

Elevator safety brakes (also known as safeties), which are typically located on the elevator car and/or counterweight, clamp onto the elevator rails when activated to hold the elevator car and/or counterweight in place.

It is known that safety is of primary concern within elevator systems, especially when an emergency occurs, and the elevator car needs to be brought to an immediate and safe stop, for example in the event of a rope breakage. The determining of when the elevator car needs to be brought to a stop is generally based on determining when the car is running at an overspeed.

Elevator systems are known to include a speed sensor on the elevator car to monitor the speed of the elevator car, and compare this speed to an expected speed profile for known elevator car movements, for example for travel between specified floor. An elevator control system monitors the speed of the elevator car, in some embodiments continuously, with regard to the predefined overspeed threshold, and if the speed of the elevator car is above the overspeed threshold, it decides the speed is abnormal and the control system applies the emergency braking apparatus.

### SUMMARY

According to a first aspect of this disclosure there is provided an elevator safety system for an elevator system comprising: a position reference system configured for determining a current position of an elevator car within the elevator system; at least one brake configured to bring the elevator car to a safe stop; a controller configured to activate the at least one brake; wherein the controller is configured to: receive data from the position reference system; calculate a current acceleration from the current position of the elevator car; compare the current acceleration to a predetermined acceleration threshold; and activate the at least one brake when the current acceleration exceeds the predetermined acceleration threshold

The controller may be a separate on car controller which is configured to act as the controller for the elevator safety system or in combination with the main controller.

The elevator safety system may comprise the on car controller and/or an elevator system controller provided remotely from the elevator car. The controller may comprise an elevator system controller provided remotely from the elevator car.

The predetermined acceleration threshold may be a predetermined acceleration threshold value. The predetermined acceleration threshold value may be in the range 8-9.8 m/s2. The predetermined acceleration threshold value may be in the range 8.5-9.5 m/s2. The predetermined acceleration threshold value may be 9 m/s2. The predetermined acceleration threshold value may be less than 8 m/s2 or greater than 9.8 m/s2.

The predetermined acceleration threshold may be in the form of a profile of expected acceleration between a first landing and a second landing. The controller may be further configured to compare the current acceleration to a predetermined acceleration threshold profile. The predetermined acceleration threshold profile may include a first acceleration region, a second zero acceleration (constant speed) region and a third deceleration region.

The maximum predetermined acceleration threshold may be in the range 8-9.8 m/s2. The maximum predetermined acceleration threshold may be in the range 8.5-9.5 m/s2. The maximum predetermined acceleration threshold may be 9 m/s2. The maximum predetermined acceleration threshold may be less than 8 m/s2 or greater than 9.8 m/s2.

The position reference system may be any suitable system configured to measure the current position of the elevator car.

The position reference system may comprise a position reference system having at least one position reference detector provided on the elevator car. The position reference system may have one or more corresponding elements provided within a hoistway of the elevator system.

The position reference system may comprise an absolute position reference system. The position reference system may be configured to detect a current position by reading coded information provided within the hoistway. The position reference system may comprise an absolute position reference detector provided on the elevator car. The absolute position reference system may have one or more corresponding elements provided within a hoistway of the elevator system. The position reference detector may be a camera. The corresponding element may be a coded tape provided on a side wall of the hoistway. The coded tape may comprise may be physical, optical, or magnetic marks or materials embedded along the length of the tape. Alternatively, the corresponding elements may comprise a plurality of indicia, for example physical, optical, or magnetic marks or materials, provided along a hoistway wall.

The absolute position reference system may have a plurality of absolute position reference detectors placed within a housing with a predetermined horizontal and/or vertical offset.

The position reference system may be configured to scan indicia provided on the coded tape, and provide data indicative of the car's position to the controller.

The position reference system may comprise an incremental position reference system. The position reference system may be configured to detect a current position by measuring movement relative to a known position.

The position reference system may be an optical system. The absolute position reference system may include one or more cameras. The position reference system may be a magnetic system.

The position reference system may be configured to determine the current position using relative barometric pressure. The position reference system may comprise a barometric pressure sensor provided on the elevator car, and a reference barometric pressure provided at a known location within the hoistway. The position reference system may be configured to compare a current barometric pressure of the elevator car to a reference barometric pressure at a known location within the hoistway.

The controller may be configured to calculate a current speed from the current position of the elevator car. The controller may be configured to compare the current speed to a predetermined speed threshold. The controller may be configured to activate the at least one brake when the current speed exceeds the predetermined speed threshold.

The controller may be further configured to compare the current speed to a predetermined speed threshold profile. The speed threshold profile may include a first region with increasing speed, a second constant speed region and a third region with decreasing speed.

According to a further aspect, there is provided an elevator system comprising: a hoistway extending between a plurality of landings; an elevator car configured for moving along the hoistway between the plurality of landings; and an elevator safety system as described above.

According to a further aspect, there is provided a method for operating an elevator safety system comprising: receiving, from a position reference system, continuous position data associated with a current position of an elevator car; calculating from the continuous position data, a current acceleration associated with the elevator car; comparing the current acceleration with a predetermined acceleration threshold; activating the at least one brake when the current acceleration exceeds a predetermined acceleration threshold.

The predetermined acceleration threshold may be a predetermined acceleration threshold value. The predetermined acceleration threshold may be in the range 8-9.8 m/s2. The predetermined acceleration threshold value may be in the range 8.5-9.5 m/s2. The predetermined acceleration threshold value may be 9 m/s2.

The method may comprise comparing the current acceleration to a predetermined acceleration threshold profile. The predetermined acceleration threshold profile may include a first acceleration region, a second zero acceleration (constant speed) region and a third deceleration region.

The absolute position reference system may comprise an absolute position reference detector provided on the elevator car and one or more corresponding elements provided within a hoistway of the elevator system.

The position reference system may comprise a position reference detector provided on the elevator car and one or more corresponding elements provided within a hoistway of the elevator system. The position reference detector may be a camera and the corresponding element may be a coded tape provided on a side wall of the hoistway. The position reference detector may be configured to scan indicia provided on the coded tape, and provide data indicative of the car's position to the controller. The coded tape may comprise physical, optical, or magnetic marks or materials embedded along the length of the tape. The corresponding elements may comprise a plurality of indicia, for example physical, optical, or magnetic marks or materials, provided along a hoistway wall.

The position reference system may be an optical system. The position reference system may be a magnetic system.

The step of determining the current position may comprise scanning indicia provided on the coded tape, and providing data indicative of the car's position to the controller.

The step of determining the current position may comprise an incremental position reference system. The step of determining the current position detecting a current position by measuring movement relative to a known position.

The step of determining the current position may comprise using relative barometric pressure. The step of determining the current position may comprise comparing a current barometric pressure of the elevator car to a reference barometric pressure at a known location within the hoistway.

The method may comprise calculating a current speed from the current position of the elevator car. The method may comprise comparing the current speed to a predetermined speed threshold. The method may comprise activating the at least one brake when the current speed exceeds the predetermined speed threshold.

The predetermined speed threshold may be a predetermined speed threshold value. The controller may be further configured to compare the current speed to a predetermined speed threshold profile. The speed threshold profile may include a first region with increasing speed, a second constant speed region and a third region with decreasing speed.

The system and method described above provide an economical solution, which can easily be retrofitted into existing elevator systems.

### DRAWING DESCRIPTION

Certain preferred examples of this disclosure will now be described, by way of example only, with reference to the accompanying drawings, in which:

FIG. 1 is a schematic illustration of an elevator system which may employ various embodiments of the present disclosure;

FIG. 2 illustrates a schematic view of the elevator safety system, in accordance with an embodiment of the disclosure; and

FIG. 3 is a flow chart of a method for operating the elevator safety system, in accordance with an embodiment of the disclosure;

FIG. 4a shows an example threshold profile for the acceleration of the elevator system of FIG. 1;

FIG. 4b shows an example threshold profile for the speed of the elevator system of FIG. 1; and

FIG. 5 is a flow chart of a method for operating the elevator safety system, in accordance with an embodiment of the disclosure.

### DETAILED DESCRIPTION

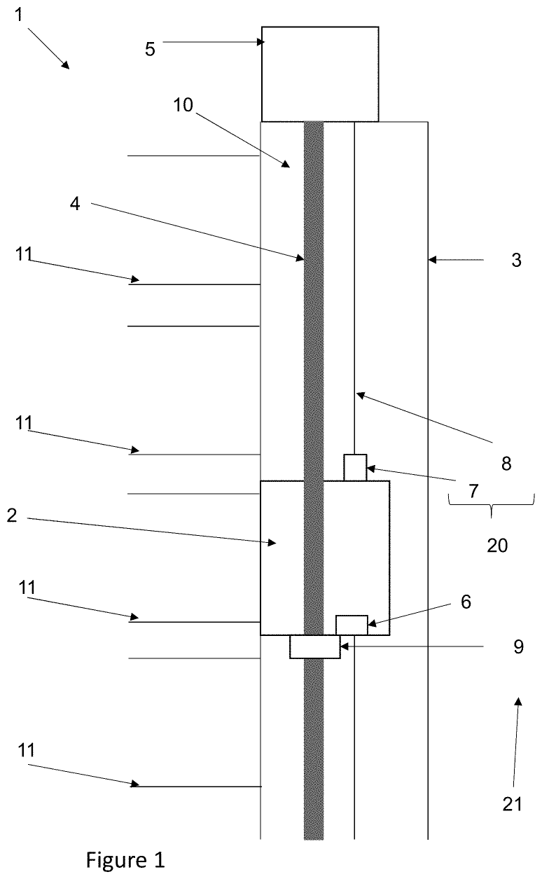

FIG. 1 is a schematic illustration of an elevator system 1 including an elevator car 2, a hoistway 3 having side walls 10, guide rail 4, a machine room 5, a controller 6, an position reference system 20, a brake 9 (also known as safety brake), and a plurality of landings 11.

Whilst only one brake 9 and one guide rail 4 are shown in FIG. 1, it will be appreciated that a guide rail 4 is typically disposed on both sides of the hoistway 3 and a brake 9 is disposed on each side of the elevator car 2 (the two brakes 9 are often referred to as “safeties”). The elevator car 2 is guided by the guide rail(s) 4 disposed on the side walls 10 of the hoistway 3. In one embodiment, there may only be a single guide rail 4. In one embodiment, there may be three or more guide rails 4. The brake(s) 9 is attached to the bottom of the elevator car 2 and the guide rail 4. The controller 6 is a safety PCB (printed circuit board) provided on the elevator car 2 and is configured to apply the brakes 9.

In another example (not shown) the controller 6 can be the elevator controller, which is configured to control the elevator system 1 including, but not limited to, moving the elevator car 2 between a plurality of landings 11 and controlling the brakes 9. The elevator controller may be located in the machine room 5 or any suitable location within or near the elevator system 1. The elevator controller 6 could be positioned in a variety of locations such as but not limited to being a wireless controller, and in elevator systems without machine rooms. In one embodiment, the elevator controller may be located remote from the elevator system 1 or in the cloud.

The position reference system 20 is configured to determine a current position of the elevator car 2 with the hoistway 3. The position reference system 20 in the example of FIG. 1 comprises an absolute position reference system 20 having an absolute position reference detector 7 and a hoistway component 8 which is located on one of the side walls 10 of the hoistway 3. The absolute position reference detector 7 is attached to the elevator car 2 and configured to interact with the hoistway component 8 to determine a current position of the elevator car 2.

Location data from the absolute position reference detector 7 is sent to the controller 6. The controller 6 can make a decision based on the output of the absolute position reference detector 7 such as when to apply the brake 9 to bring the elevator car 2 to a safe stop, either due to an emergency or to stop the elevator car 2 at one of the plurality of landings 11.

An elevator safety system 21 comprises the absolute position reference system 20, the controller 6 and the brake(s) 9.

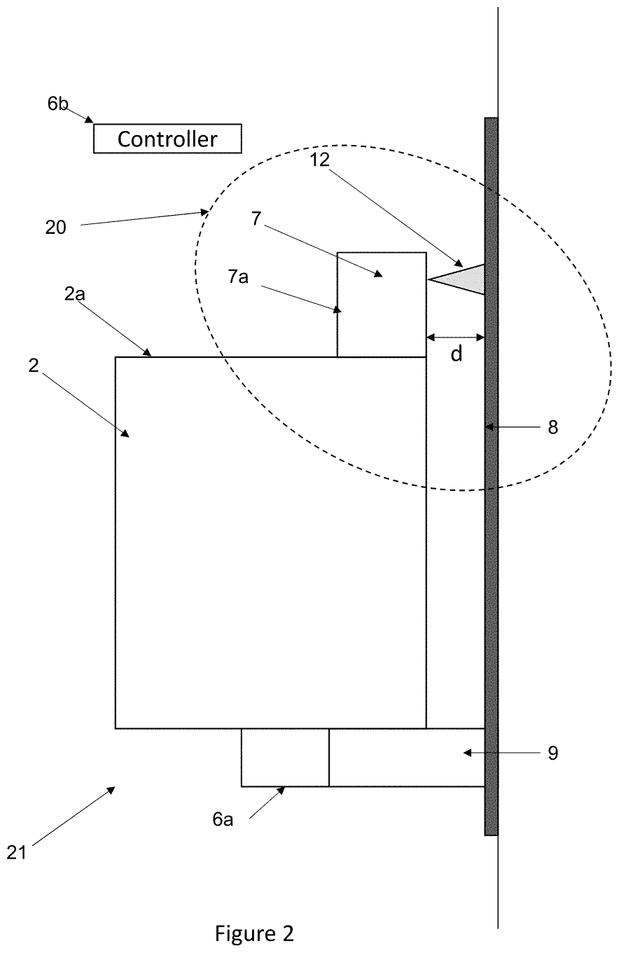

Referring now to FIG. 2 showing the elevator safety system 21 of FIG. 1 with a simplified depiction of the elevator car 2 and the position reference system 20, which in this example is an optical system. Generally optical position reference systems 20 include an encoded tape or strip as the hoistway component 8, mounted within the hoistway 3 that extends along the length of said hoistway 3. The tape/strip 8 comprises indicia upon the tape/strip 8 for identifying vertically spaced locations along the hoistway 3. The absolute position reference detector 7 is an optical sensor 7 which is mounted on the elevator car 2 and is configured for optically reading location related indicia contained upon the tape/strip.

In this example, the controller 6 comprises an on car controller 6a and an elevator system controller 6b.

In this example, the absolute position reference detector 7 is a camera 7, and the hoistway component 8 is a coded tape 8. The camera 7 reads data from the coded tape 8. The camera 7 provided in a housing 7a which is located on a top 2a of the elevator car 2, adjacent to the side wall 10 and at a distance from the encoded tape 8 located on the side wall 10 of the hoistway 3. The camera 7 reads a set proportion of the encoded tape 8 depicted by the angle of view 12. The camera 7 scans the encoded tape 8 which provides data indicative of the car's position along the tape 8.

In this example the absolute position reference detector 7 is disposed on the roof 2a of the elevator car 2, but it will be appreciated that it could be disposed anywhere on the elevator car 2 where it does not interfere with other systems and there is no interruption across the angle of view 12 to the encoded tape 8.

In another example (not shown), two absolute position reference detectors 7 are secured to the elevator car 2 in vertical spaced apart alignment and arranged to read two vertically separated code rail sections 8 simultaneously to acquire a range of position related information.

In another example (not shown) the absolute position reference system 20 has a plurality of absolute position reference detectors 7 placed within a housing with a predetermined horizontal and/or vertical offset. This introduces a redundancy where the loss of data from one absolute position reference detector 7 can be compensated for.

The absolute position reference detector 7 continuously monitors the current position of the elevator car 2 with respect to time. The data from the absolute position reference detector 7 is then transmitted to the controller 6. With this data the controller 6 decides when the elevator car 2 needs to be stopped, taking into account any elevator call request. During normal operation the elevator car 2 travels between from a first landing 11 to a destination landing 11, in accordance with a current elevator call request. The elevator car 2 starts moving at the first landing 11, the elevator car 2 is then accelerated to a normal operating speed at which it stays until at a defined position at which it decelerates to allow the elevator car 2 to stop at the destination landing 11. The profiles for acceleration and speed of the elevator car 2 as it moves between landings 11 are predefined for specific elevator car journeys, and known by the controller 6.

It will be appreciated that whilst an optical absolute position reference system is described above, any suitable system which is configured to determine positions from coordinate origins that can never change can be used.

Another known position reference system 20 is an incremental position reference system which is configured to count small steps from a known position. This type of system uses a reference point across the hoistway to avoid drift. For example, an incremental position reference system may include an encoder that is mounted upon a drive shaft of an elevator drive motor, and may be known to those in the art as an incremental position reference system. Elevator car 2 position data is determined by the encoder. Additional sensors and vanes may be provided at each landing 1 and the position of the elevator car 2 as derived by the encoder is checked and corrected if needed each time the elevator car 2 passes a vane at a landing 11

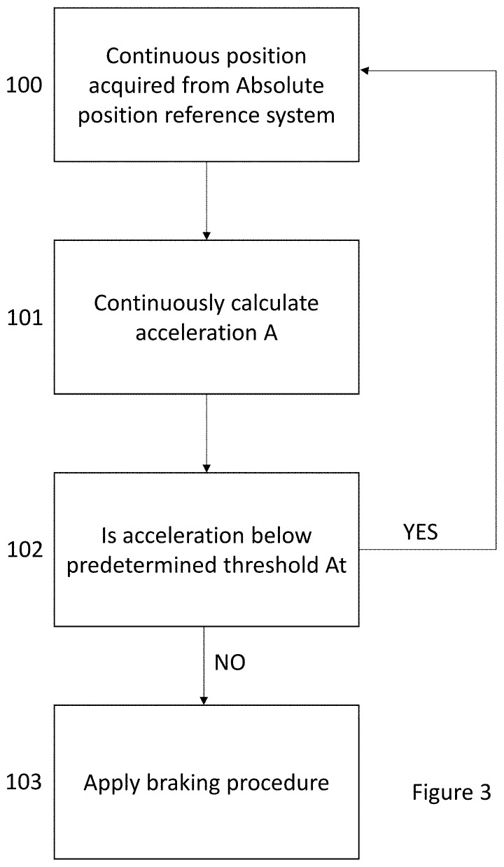

FIG. 3 is a flow chart that outlines an example of method to decide when emergency braking is to be applied. The controller 6 is acquiring position data with respect to time from the position reference detector 7 (step 100). Using this data the controller 6 can calculate a current acceleration A of the elevator car 2 (step 101).

In step 102 the current acceleration A is compared with a predetermined acceleration threshold At, for example, a predetermined acceleration threshold value. The current acceleration should always be below the predetermined acceleration threshold value At. Whilst the current acceleration A is below the predetermined acceleration threshold At, normal operation of the elevator system 1 can proceed. If the acceleration at any point during the elevator car journey exceeds the predetermined acceleration threshold value At, the controller 6 determines that there is something wrong with the elevator system 1. At this point in time the brakes 9 are applied to bring the elevator car 2 to a safe stop, keeping the passengers in the elevator car 2 safe (step 103).

The predetermined acceleration threshold At in this example is a maximum threshold value. The predetermined acceleration threshold value may be in the range 8-9.8 m/s². The predetermined acceleration threshold value may be in the range 8.5-9.5 m/s² The predetermined acceleration threshold value may be 9 m/s².

The predetermined acceleration threshold At can also be in the form of a profile of expected acceleration between the plurality of landings 11. Where the acceleration threshold is a profile, it will be different at different locations within the profile of movement of the elevator car 2 for a given elevator car journey. The allowable tolerances for the acceleration over the expected acceleration profile may be different at different parts of the movement, in particular where an increase in acceleration is likely to be more dangerous, for example when the elevator car 2 should be decelerating to a stop by the destination landing 11. In this case, the current acceleration A is compared to the known profile for acceleration for a given elevator car journey, for example moving downwards over a defined distance.

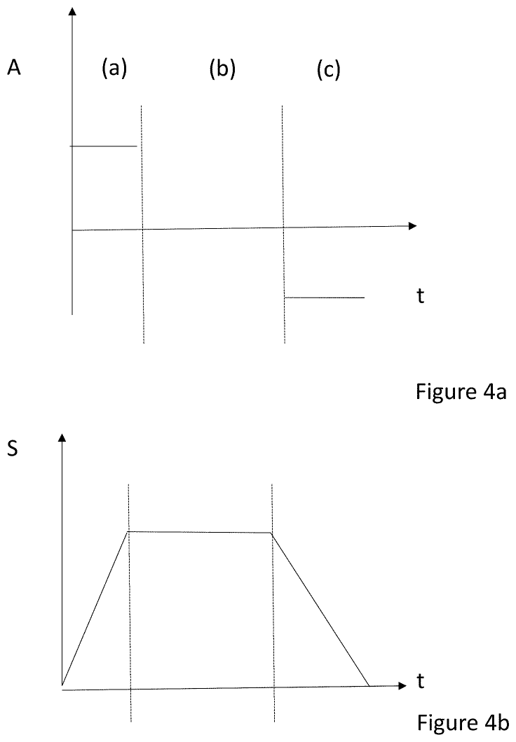

FIG. 4a shows an example threshold profile for the acceleration of an elevator car 2 moving between landings 11. Acceleration is represented along the vertical axis, and journey time along the horizontal axis. At the start of the motion in region (a), the elevator car 2 accelerates, then in region (b) it moves at a constant speed before decelerating in region (c) as it approaches its destination. In step 102, the controller 6 compares the current acceleration A against the acceleration profile during the journey. In any region, if the current acceleration exceeds the threshold for that region, the controller 6 applies the brakes 9 to carry out an emergency stop. For example, in region (b), it is expected that the elevator car 2 will travel at a constant speed, in other words there will be no acceleration. If the elevator car experiences unexpected acceleration in region (b), this could be indicative of a safety critical issue, such as rope failure.

FIG. 4b shows an example threshold profile for the speed of an elevator car 2 moving between landings 22. Speed is represented along the vertical axis, and journey time along the horizontal axis. This is used in the example described below.

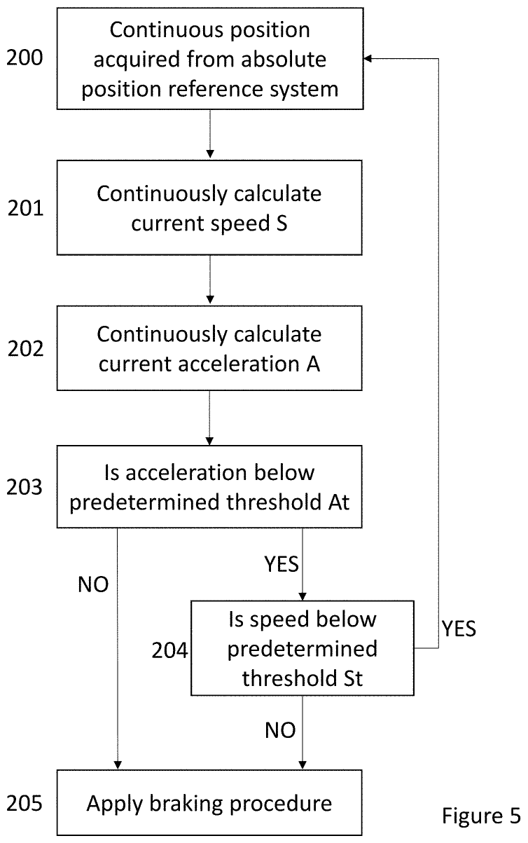

FIG. 5 shows an embodiment further example of a method to decide when emergency braking is applied. In the example of FIG. 5, both the current speed and the current acceleration of the elevator car 2 are monitored. The controller 6 is acquiring continuous position data from the absolute position reference detector 7 relating to the current position of the elevator car 2 (step 200). Using the data the controller 6 can continuously calculate a current speed S of the elevator car 2 (step 201), and a current acceleration A of the elevator car 2 (step 202). The current acceleration A is compared to the predetermined acceleration threshold value At. The current speed S is compared to the predetermined speed threshold value St. The current acceleration A should always be remain below the predetermined threshold value At for acceleration (step 203). The current speed S should also remain below a predetermined threshold value St for speed (step 204). Whilst the current acceleration A (step 203) and current speed S (step 204) of the elevator car 2 are below the respective predetermined thresholds, normal operation of the elevator system 1 can proceed.

If the current acceleration A exceeds the predetermined acceleration threshold At, the brakes 9 are applied (step 205). This check allows the controller 6 to identify a potentially dangerous situation even when a maximum speed is not yet reached. For example, if a component fails, the elevator car 2 may accelerate very quickly in a free fall state. By detecting the abnormal acceleration quickly, the brakes 9 can be applied promptly.

If the current acceleration A is still below the predetermined acceleration threshold At, but the current speed S is above the predetermined speed threshold St for any reason, the brakes 9 are applied (step 205).

The predetermined thresholds in this example are set threshold values. However, it will be appreciated that the predetermined acceleration threshold can also be in the form of a profile of expected acceleration, as shown in FIG. 4a, and the predetermined speed threshold can also be in the form of a profile of expected speed between the plurality of landings 11 as shown in FIG. 4b.

In this case, the current acceleration A is compared to the known profile for acceleration at the current position of the elevator car 2 during its journey (step 203). The current speed S is compared to the known profile for speed at the specific location of the current elevator car 2 run between the first landing and destination landing 11 (step 204). The current acceleration A should always be remain below the predetermined threshold value for acceleration At (step 203). The current speed S should also remain below a predetermined speed threshold St (step 204). Whilst the current acceleration A (step 203) and current speed S (step 204) of the elevator car 2 are below the respective predetermined thresholds At and St, normal operation of the elevator system can proceed.

Although in FIG. 3 and FIG. 5, these method steps are seen as following on from one another, it will be appreciated that every step could be happening continuously within a processor, allowing an almost instant response to any changes of acceleration or speed outside the given thresholds. In an elevator system the expected response time is 0-100 ms, where delays over 100 ms are not fast enough to respond safely to an emergency stopping situation.

In these examples the threshold values are used to determine when to apply brakes to bring the elevator car to a safe stop. In an additional example (not shown) continuous monitoring of speed and acceleration can be used for diagnostic purposes.

It will be appreciated by those skilled in the art that the disclosure has been illustrated by describing one or more specific aspects thereof, but is not limited to these aspects; many variations and modifications are possible, within the scope of the accompanying claims.

What is claimed is:

1. An elevator safety system (21) for an elevator system (1) comprising:
a position reference system (20) configured to determine a current position of an elevator car (2) within the elevator system (1);
at least one brake (9) configured to bring the elevator car (2) to a safe stop; and
a controller (6) configured to activate the at least one brake (9);
wherein the controller (6) is configured to:
receive data from the position reference system (20)
calculate a current acceleration (A) from the current position of the elevator car (2);
compare the current acceleration (A) to a predetermined acceleration threshold (At); and
activate the at least one brake (9) when the current acceleration (A) exceeds the predetermined acceleration threshold (At).

2. The elevator safety system (21) according to claim 1, wherein the predetermined acceleration threshold (At) is in the form of a profile of expected acceleration between a first landing and a second landing.

3. The elevator safety system (21) according to claim 1, wherein the predetermined acceleration threshold (At) is a predetermined acceleration threshold value.

4. The elevator safety system (21) according to claim 2, wherein a maximum predetermined acceleration threshold (At) is in the range 8-9.8 m/s².

5. The elevator safety system (21) according to claim 1, wherein the position reference system (20) comprises a position reference detector (7) provided on the elevator car (2) and one or more corresponding elements (8) provided within a hoistway (3) of the elevator system (1).

6. The elevator safety system (21) according to claim 1, wherein the position reference system (20) is an optical system.

7. The elevator safety system (21) according to claim 1, wherein the controller (6) is an on car controller (6a).

8. The elevator safety system (21) according to claim 1, wherein the controller (6) is configured to
calculate a current speed (S) from the current position of the elevator car (2);
compare the current speed (S) to a predetermined speed threshold (St); and
activate the at least one brake (9) when the current speed (S) exceeds the predetermined speed threshold (St).

9. An elevator system (1) comprising:
a hoistway (3) extending between a plurality of landings (11);
an elevator car (2) configured for moving along the hoistway (3) between the plurality of landings (11); and
an elevator safety system (21) according to claim 1.

10. A method (100, 200) for operating an elevator safety system (21), the method comprising:
receiving, from a position reference system (20), position data associated with a current position of an elevator car (2);
calculating from the continuous position data, a current acceleration (A) associated with the elevator car (2);
comparing the current acceleration (A) with a predetermined acceleration threshold (At);
activating the at least one brake (9) when the current acceleration (A) exceeds a predetermined acceleration threshold (At).

11. The method (100, 200) of claim 10, wherein the predetermined acceleration threshold (At) is in the form of a profile of expected acceleration between a first landing and a second landing.

12. The method (100, 200) of claim 10, wherein the predetermined acceleration threshold (At) is a predetermined acceleration threshold value.

13. The method of claim 11, wherein a maximum predetermined acceleration threshold (At) is in the range 8-9.8 m/s².

14. The method (100, 200) of claim 10, wherein the position reference system (20) comprises a position reference detector (7) provided on the elevator car (2) and one or more corresponding elements (8) provided within a hoistway (3) of the elevator system (1).

15. The method (100, 200) of claim 10, comprising
calculating a current speed (S) from the current position of the elevator car (2);
comparing the current speed (S) to a predetermined speed threshold (St); and
activating the at least one brake (9) when the current speed (S) exceeds the predetermined speed threshold (St).
